(19) United States
(12) Patent Application Publication
(10) Pub. No.: US 2017/0176813 A1
(43) Pub. Date: Jun. 22, 2017

(54) A DISPLAY PANEL AND A MANUFACTURING METHOD THEREOF, A DISPLAY DEVICE

(71) Applicants: BOE TECHNOLOGY GROUP CO., LTD., Beijing (CN); HEFEI BOE OPTOELECTRONICS TECHNOLOGY CO., LTD., Hefei, Anhui Province (CN)

(72) Inventors: Shounian CHEN, Beijing (CN); Site CAI, Beijing (CN)

(21) Appl. No.: 15/124,666

(22) PCT Filed: Sep. 16, 2015
(86) PCT No.: PCT/CN2015/089763

§ 371 Date: Sep. 8, 2016

(30) Foreign Application Priority Data
May 27, 2015 (CN) 201510278511.4

(51) Int. Cl. G02F 1/1335

(52) U.S. Cl. CPC G02F 1/133553; G02F 1/133514; G02F 1/133512; G02F 1/133516; G02F 2203/01; G02F 2202/28; G02F 2001/133302

(57) ABSTRACT

The present disclosure provides a display panel and a manufacturing method thereof, and a display device, for improving light efficiency utilization rate of the backlight source. The display panel comprises an array substrate and a color film substrate arranged opposite to each other, and a liquid crystal layer located between the array substrate and the color film substrate. The color film substrate comprises a black matrix. The display panel further comprises a reflecting layer. The reflecting layer is located at a side of the array substrate away from the color film substrate. An area of the reflecting layer corresponds to an area of the black matrix.

The present application is the U.S. national phase entry of PCT/CN2015/089763, with an international filing date of Sep. 16, 2015, which claims the benefit of Chinese Patent Application No. 201510278511.4, filed on May 27, 2015, the entire disclosure of which is incorporated herein by reference.

### TECHNICAL FIELD

The present disclosure relates to the field of display technology, particularly to a display panel and a manufacturing method thereof, and a display device.

### BACKGROUND

The liquid crystal display (LCD) is the commonly used panel display at present. The liquid crystal display has been widely studied and applied by right of its advantages of low voltage, low power consumption, suitable for circuit integration, light and portable etc.

In the prior art, a liquid crystal display panel comprises an array substrate and a color film substrate arranged opposite to each other, and a liquid crystal layer located between the array substrate and the color film substrate. In the liquid crystal display panel, an area of light transmission is a pixel area. Other structures such as thin film transistors (TFTs) and circuitry exist between the pixel areas. In order to enable these structures not to affect the display image, a black non-transparent resin is coated on the color film substrate of the liquid crystal display panel through masking process generally. The pattern array consisting of these black areas is called a black matrix (BM). As shown in FIG. 1, the color film substrate comprises a color film layer and a black matrix 11. The color film layer comprises several color sub-pixels arranged in arrays, specifically, comprising several red (R) sub-pixels, green (G) sub-pixels and blue (B) sub-pixels arranged in arrays.

When the liquid crystal display panel is displaying, the light emitted from the backlight source passes through the array substrate and the color film substrate successively and is emitted from the light transmissive pixel area for display. The black matrix has an ability to absorb light, such that a considerable part of light emitted from the backlight source is absorbed and consumed by the black matrix, which results in a relatively low light efficiency utilization rate of the backlight source. In one pixel, the ratio that light transmission area occupies the whole pixel area is called an aperture ratio. The lower the aperture ratio of the liquid crystal display panel is, the larger the ratio of area occupied by the black matrix is. In the current development trend that the liquid crystal display panel has a higher and higher pixel, the aperture ratio of the liquid crystal display panel will be sacrificed for high pixels. In this way, the area occupied by the black matrix becomes larger and larger, and the light efficiency consumption of the backlight source caused by the black matrix will also be larger and larger.

To sum up, in the prior art, with the increase of the area occupied by the black matrix in the color film substrate, the light efficiency utilization rate of the backlight source is relatively low.

### SUMMARY

Embodiments of the present disclosure provide a display panel and a manufacturing method thereof, and a display device, for improving light efficiency utilization rate of the backlight source.

Embodiments of the present disclosure provide a display panel, comprising an array substrate and a color film substrate arranged opposite to each other, and a liquid crystal layer located between the array substrate and the color film substrate. The color film substrate comprises a black matrix. The display panel further comprises a reflecting layer. The reflecting layer is located at a side of the array substrate away from the color film substrate. An area of the reflecting layer corresponds to an area of the black matrix.

Since the display panel provided by embodiments of the present disclosure comprises a reflecting layer, and the reflecting layer is located at a side of the array substrate away from the color film substrate, an area of the reflecting layer corresponds to an area of the black matrix, when the display panel provided by embodiments of the present disclosure is displaying, the reflecting layer comprised by the display panel enables the light that is originally emitted by the backlight source to the black matrix to be reflected back to the backlight source. Such light can be utilized again so as to avoid from being absorbed by the black matrix, thereby improving light efficiency utilization rate of the backlight source.

According to an embodiment, the display panel can further comprises a transparent substrate. The transparent substrate is adhered to the side of the array substrate away from the color film substrate. The reflecting layer is arranged at a side of the transparent substrate away from the array substrate.

According to an embodiment, a material of the reflecting layer can be metal aluminum or metal argentum.

According to an embodiment, the transparent substrate can be adhered to the array substrate through a transparent adhesive.

According to an embodiment, the transparent substrate can be a glass substrate.

Embodiments of the present disclosure further provide a display device. The display device can comprise a display panel in any of the above embodiments.

Embodiments of the present disclosure further provide a method of manufacturing a display panel. The method comprises manufacturing an array substrate and a color film substrate arranged opposite to each other, and manufacturing a liquid crystal layer between the array substrate and the color film substrate. The color film substrate comprises a black matrix. The method further comprises manufacturing a reflecting layer at a side of the array substrate away from the color film substrate. An area of the reflecting layer corresponds to an area of the black matrix.

According to an embodiment, manufacturing a reflecting layer at a side of the array substrate away from the color film substrate can comprise: depositing a reflective film layer with a light reflection effect at a side of the array substrate away from the color film substrate; forming a reflecting layer by performing a patterning process to the reflective film layer.

According to an embodiment, manufacturing a reflecting layer at a side of the array substrate away from the color film substrate can comprise: providing a transparent substrate; manufacturing a reflecting layer on the transparent substrate; adhering the transparent substrate manufactured with the reflecting layer to a side of the array substrate away from the color film substrate, the reflecting layer being located at a side of the transparent substrate away from the array substrate when adhering.

According to an embodiment, manufacturing a reflecting layer on the transparent substrate can comprise: depositing a reflective film layer with a light reflection effect on the transparent substrate; forming a reflecting layer by performing a patterning process to the reflective film layer.

Alternatively, manufacturing a reflecting layer on the transparent substrate can comprise: shielding the transparent substrate using a model manufactured with a hollow area in advance, the hollow area corresponding to an area of the black matrix; depositing a reflective film layer with a light reflection effect on the shielded transparent substrate, so as to form a reflecting layer.

### BRIEF DESCRIPTION OF THE DRAWINGS

FIG. 1 is a schematic view of a planar structure of a color film substrate of the prior art;

FIG. 2 is a schematic view of a cross-section structure of a display panel provided by embodiments of the present disclosure;

FIG. 3 is a schematic view of a cross-section structure of another display panel provided by embodiments of the present disclosure;

FIG. 4 is a flow chart of a method of manufacturing a reflecting layer by using method I of embodiments of the present disclosure;

FIG. 5 is a flow chart of a method of manufacturing a reflecting layer by using method II of embodiments of the present disclosure;

FIG. 6 is a schematic view of a planar structure of a reflecting layer manufactured by using method II of embodiments of the present disclosure.

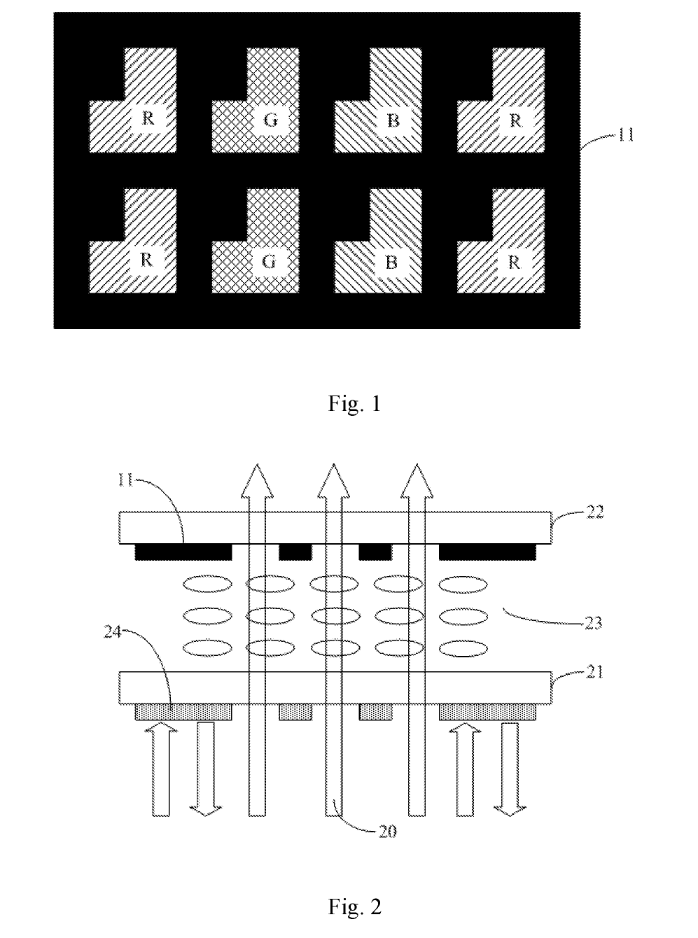

### DETAILED DESCRIPTION

In order to enable the purposes, technical solutions and advantages of the present disclosure to be clearer, the present disclosure will be described in more detail with reference to the drawings next. Apparently, the embodiments described are only part of rather than all of the embodiments of the present disclosure. Based on the embodiments in the present disclosure, all other embodiments obtained by the ordinary skilled person in the art without any creative work belong to the protection scope of the present disclosure.

Embodiments of the present disclosure provide a display panel and a manufacturing method thereof, and a display device, for improving light efficiency utilization rate of the backlight source.

Next, the display panel provided by a specific embodiment of the present disclosure will be introduced in detail with reference to the drawings.

As shown in FIG. 2, the specific embodiment of the present disclosure provides a display panel, comprising an array substrate 21 and a color film substrate 22 arranged opposite to each other, and a liquid crystal layer 23 located between the array substrate 21 and the color film substrate 22. The color film substrate 22 comprises a black matrix 11. The display panel provided by the specific embodiment of the present disclosure further comprises a reflecting layer 24. The reflecting layer 24 is located at a side of the array substrate away from the color film substrate 22. An area of the reflecting layer 24 corresponds to an area of the black matrix 11. Preferably, the material of the reflecting layer 24 in the specific embodiment of the present disclosure is metal aluminum (Al) or metal argentum (Ag). The metal aluminum or metal argentums has a good effect of light reflection. The reflecting layer 24 can also use other materials with a good effect of light reflection.

When the display panel in the specific embodiment of the present disclosure is displaying, the light 20 emitted from the backlight source passes through the display panel of the specific embodiment of the present disclosure. One part of light is emitted from the light transmissive pixel area. The other part of light irradiates onto the reflecting layer 24 and is reflected back to the backlight source. Such light can be utilized again. Compared with this part of light in the display panel in the prior art being absorbed by the black matrix 11, the display panel provided by the specific embodiment of the present disclosure improves light efficiency utilization rate of the backlight source.

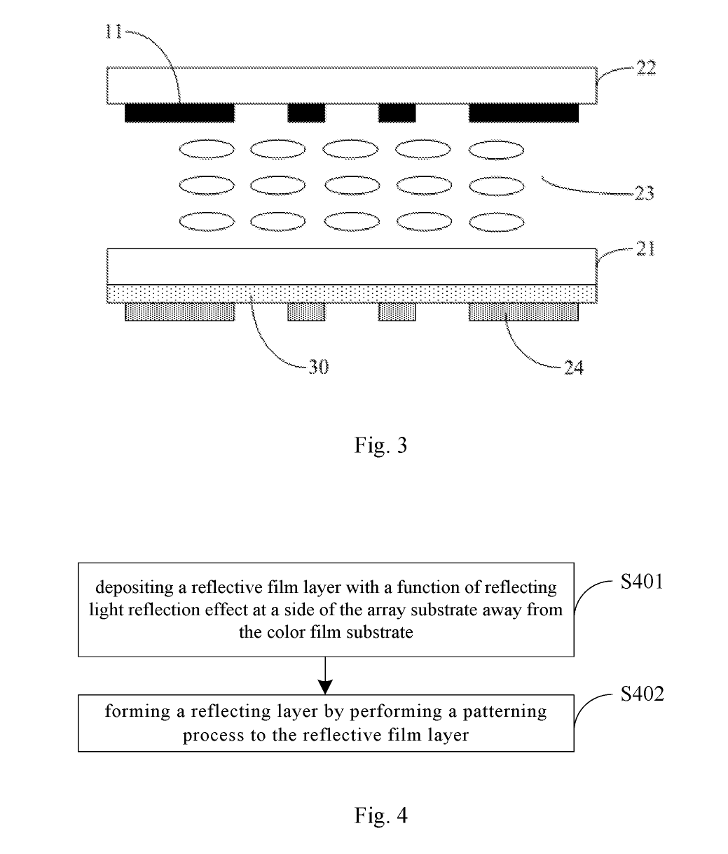

As shown in FIG. 3, the display panel provided by the specific embodiment of the present disclosure can further comprise a transparent substrate 30. The transparent substrate 30 is adhered to a side of the array substrate 21 away from the color film substrate 22. The reflecting layer 24 is arranged at a side of the transparent substrate 30 away from the array substrate 21. Preferably, the transparent substrate 30 in the specific embodiment of the present disclosure can be adhered to the array substrate 21 through a transparent adhesive.

A specific embodiment of the present disclosure further provides a display device. The display device comprises the above display panel. The display device can be a liquid crystal panel, a liquid crystal display, a liquid crystal television, an organic light emitting diode (OLED) panel, an OLED display, an OLED television or electronic paper etc.

A specific embodiment of the present disclosure further provides a method of manufacturing a display panel. The method comprises manufacturing an array substrate 21 and a color film substrate 22 arranged opposite to each other, cell-aligning the array substrate 21 and the color film substrate 22, and manufacturing a liquid crystal layer 23 between the array substrate 21 and the color film substrate 22. The color film substrate 22 comprises a black matrix 11. The method further comprises manufacturing a reflecting layer 24 at a side of the assembled array substrate 21 away from the color film substrate 22. An area of the reflecting layer 24 corresponds to an area of the black matrix 11.

The method of manufacturing a array substrate 21 and a color film substrate 22 arranged opposite to each other in the specific embodiment of the present disclosure is the same as that in the prior art, which will not be repeated here. The method of manufacturing a liquid crystal layer 23 between the array substrate 21 and the color film substrate 22 in the specific embodiment of the present disclosure is also the same as that in the prior art, which will not be repeated here.

The specific embodiment of the present disclosure includes two different methods of manufacturing a reflecting layer at a side of the array substrate away from the color film substrate, which will be introduced with is reference to the drawings respectively next.

Method I:

As shown in FIG. 4, the specific embodiment of the present disclosure manufacturing a reflecting layer at a side of the array substrate away from the color film substrate comprises:

S401, depositing a reflective film layer with a light reflection effect at a side of the array substrate away from the color film substrate;

S402, forming a reflecting layer by performing a patterning process to the reflective film layer.

Specifically, the specific embodiment of the present disclosure deposits a metal Al film layer or a metal Ag film layer at a side of the array substrate away from the color film substrate through evaporation coating method etc., then using a patterning process to the deposited metal Al film layer or metal Ag film layer to form a reflecting layer pattern corresponding to the black matrix area in the specific embodiment of the present disclosure.

The patterning process in the specific embodiment of the present disclosure includes the processes of photoresist coating, exposing, developing, etching and removing. Specifically, photoresist is coated on the deposited metal Al film layer or metal Ag film layer, and the coated photoresist is exposed and developed. After development, only the photoresist at the position where the reflecting layer is to be formed is reserved. The exposed metal Al film layer or metal Ag film layer is etched to remove the exposed metal Al film layer or metal Ag film layer. The residual photoresist is removed after the etching to form the reflecting layer 24 in FIG. 2 of the specific embodiment of the present disclosure.

In an actual production process, when the reflecting layer is manufactured using method I, because the manufacturing of the structures such as TFTs, pixel electrodes, and gate lines of the array substrate has been accomplished when manufacturing the reflecting layer, the structures such as TFTs, pixel electrodes, and gate lines will be influenced if depositing to the reflecting film layer and forming the reflecting layer by using the patterning process to the reflecting film layer thereafter. Similarly, if the manufacturing of the reflecting layer is accomplished firstly, the previously manufactured reflecting layer will also be influenced by the subsequently manufactured structures of TFTs, pixel electrodes, and gate lines. In an actual production process, in order to reduce the above influence, the requirements on the production device and the specific process parameters in the manufacturing process are relatively high.

Method II:

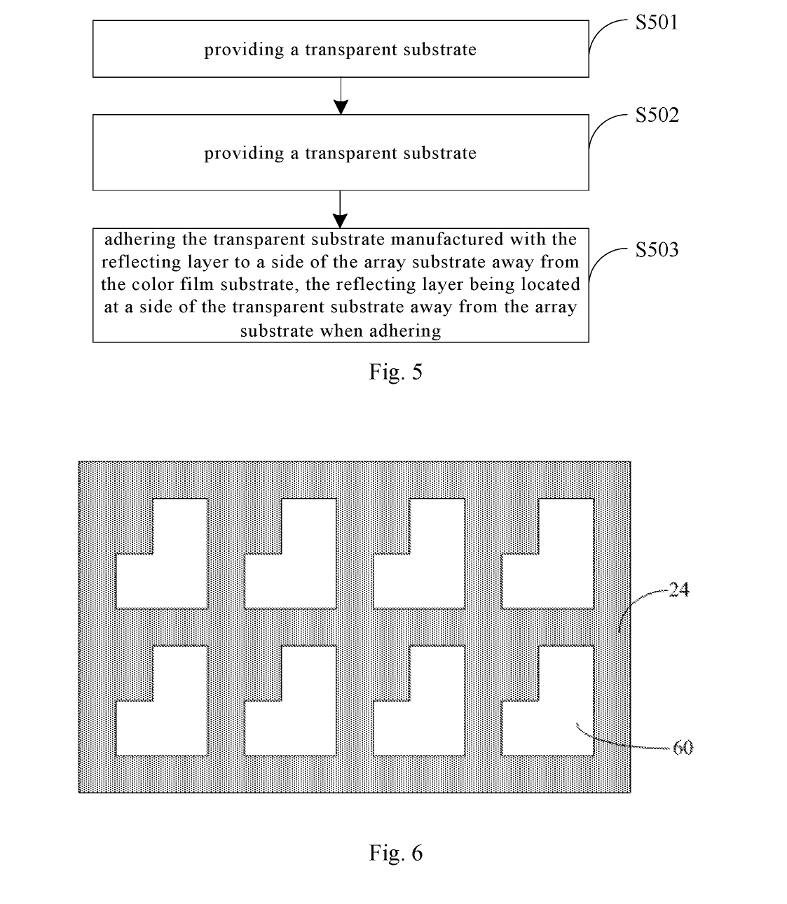

As shown in FIG. 5, the specific embodiment of the present disclosure manufacturing a reflecting layer at a side of the array substrate away from the color film substrate comprises:

S501, providing a transparent substrate;

S502, manufacturing a reflecting layer on the transparent substrate;

S503: adhering the transparent substrate manufactured with the reflecting layer to a side of the array substrate away from the color film substrate, the reflecting layer being located at a side of the transparent substrate away from the array substrate when adhering.

The specific embodiment of the present disclosure provides a transparent substrate firstly, for example, the transparent substrate provided in the specific embodiment of the present disclosure can be a glass substrate. And then, a reflecting layer is manufactured on the transparent substrate provided. The area of the reflecting layer corresponds to the area of the black matrix.

The specific embodiment of the present disclosure manufacturing a reflecting layer on the transparent substrate can comprise:

depositing a reflective film layer with a light reflection effect on the transparent substrate;

forming a reflecting layer by performing a patterning process to the reflective film layer.

Alternatively, the specific embodiment of the present disclosure manufacturing a reflecting layer on the transparent substrate can comprise:

shielding the transparent substrate using a model manufactured with a hollow area in advance, the hollow area corresponding to an area of the black matrix;

depositing a reflective film layer with a light reflection effect on the shielded transparent substrate, so as to form a reflecting layer.

Specifically, a reflecting film layer with a light reflection effect is deposited on the transparent substrate. A reflecting layer is formed by using patterning process to the reflecting film layer. The specific process of such a method in manufacturing a reflecting layer on the transparent substrate is similar to the specific process of manufacturing the reflecting layer in method I, which will not be repeated here. The transparent substrate manufactured with a reflecting layer is as shown in FIG. 6. The area of the reflecting layer 24 corresponds to the area of the black matrix. An area 60 of the transparent substrate not manufactured with a reflecting layer corresponds to the color sub-pixel of the color film substrate.

Specifically, the transparent substrate is shielded using a model manufactured with a hollow area in advance, the hollow area corresponding to an area of the black matrix. A reflective film layer with a light reflection effect is deposited on the shielded transparent substrate. When the shielded portion is deposited with a reflecting film layer with a light reflection effect, the reflecting film layer is deposited onto a model manufactured in advance; only the transparent substrate corresponding to the hollow area is deposited with the reflecting film layer. And then, the model manufactured in advance is removed, to form a reflecting layer on the transparent substrate. The transparent substrate manufactured with a reflecting layer of the specific embodiment of the present disclosure is as shown in FIG. 6. When the reflecting film layer is deposited, it is shielded using a model manufactured in advance, so that the reflecting layer can be formed on the transparent substrate without the patterning process, which is more convenient and simple in the production process.

Finally, the transparent substrate manufactured with a reflecting layer is adhered to a side of the array substrate away from the color film substrate through a transparent adhesive, the reflecting layer being located at a side of the transparent substrate away from the array substrate when adhering.

In actual production process, when the reflecting layer is manufactured using the method II, because the manufacturing process of the reflecting layer is separated from that of the array substrate, the requirements on the production device and the specific process parameters in the manufacturing process are relatively low.

To sum up, embodiments of the present disclosure provide a display panel and a manufacturing method thereof, and a display device. The display panel comprises an array substrate and a color film substrate arranged opposite to each other, and a liquid crystal layer located between the array substrate and the color film substrate. The color film substrate comprises a black matrix. The display panel further comprises a reflecting layer. The reflecting layer is located at a side of the array substrate away from the color film substrate. An area of the reflecting layer corresponds to an area of the black matrix. Since the reflecting layer in the specific embodiment of the present disclosure is located at a side of the array substrate away from the color film substrate, and an area of the reflecting layer corresponds to an area of the black matrix, compared with the prior art, when the display panel of the specific embodiment of the present disclosure is displaying, the reflecting layer comprised by the display panel enables the light that is originally emitted by the backlight source to the black matrix to be reflected back to the backlight source. Such light can be utilized again so as to avoid from being absorbed by the black matrix, thereby improving light efficiency utilization rate of the backlight source.

Apparently, the skilled person in the art can make various modifications and variations to the present disclosure without departing from the spirit and the scope of the present disclosure. In this way, provided that these modifications and variations of the present disclosure belong to the scopes of the claims of the present disclosure and the equivalent technologies thereof, the present disclosure also intends to encompass these modifications and variations.

1. A display panel, comprising an array substrate and a color film substrate arranged opposite to each other, a liquid crystal layer located between the array substrate and the color film substrate, the color film substrate comprising a black matrix, wherein the display panel further comprises a reflecting layer, the reflecting layer is located at a side of the array substrate away from the color film substrate, an area of the reflecting layer corresponds to an area of the black matrix.

2. The display panel according to claim 1, further comprising a transparent substrate, wherein the transparent substrate is adhered to the side of the array substrate away from the color film substrate, the reflecting layer is arranged at a side of the transparent substrate away from the array substrate.

3. The display panel according to claim 2, wherein a material of the reflecting layer is metal aluminum or metal argentum.

4. The display panel according to claim 3, wherein the transparent substrate is adhered to the array substrate through a transparent adhesive.

5. The display panel according to claim 4, wherein the transparent substrate is a glass substrate.

6. A display device, comprising a display panel according to claim 1.

7. A method of manufacturing a display panel, comprising manufacturing an array substrate and a color film substrate arranged opposite to each other, and manufacturing a liquid crystal layer between the array substrate and the color film substrate, the color film substrate comprising a black matrix, wherein the method further comprises manufacturing a reflecting layer at a side of the array substrate away from the color film substrate, an area of the reflecting layer corresponds to an area of the black matrix.

8. The method according to claim 7, wherein manufacturing a reflecting layer at a side of the array substrate away from the color film substrate comprises:
depositing a reflective film layer with a light reflection effect at a side of the array substrate away from the color film substrate;
forming a reflecting layer by performing a patterning process to the reflective film layer.

9. The method according to claim 7, wherein manufacturing a reflecting layer at a side of the array substrate away from the color film substrate comprises:
providing a transparent substrate;
manufacturing a reflecting layer on the transparent substrate;
adhering the transparent substrate manufactured with the reflecting layer to a side of the array substrate away from the color film substrate, the reflecting layer being located at a side of the transparent substrate away from the array substrate when adhering.

10. The method according to claim 9, wherein manufacturing a reflecting layer on the transparent substrate comprises:
depositing a reflective film layer with a light reflection effect on the transparent substrate,
forming a reflecting layer by performing a patterning process to the reflective film layer; or
shielding the transparent substrate using a model manufactured with a hollow area in advance, the hollow area corresponding to an area of the black matrix,
depositing a reflective film layer with a light reflection effect on the shielded transparent substrate, so as to form a reflecting layer.

11. The display device according to claim 6, wherein the display panel further comprises a transparent substrate, and wherein the transparent substrate is adhered to the side of the array substrate away from the color film substrate, the reflecting layer is arranged at a side of the transparent substrate away from the array substrate.

12. The display device according to claim 11, wherein a material of the reflecting layer is metal aluminum or metal argentum.

13. The display device according to claim 12, wherein the transparent substrate is adhered to the array substrate through a transparent adhesive.

14. The display device according to claim 13, wherein the transparent substrate is a glass substrate.
